(19) United States
(12) Patent Application Publication
(10) Pub. No.: US 2002/0198691 A1
(43) Pub. Date: Dec. 26, 2002

(54) Methods and systems for ars interruption modeling

(76) Inventor: Subhasish Roychoudhury, Albany, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(21) Appl. No.: 09/681,857

(22) Filed: Jun. 19, 2001

(51) Int. Cl. G06F 17/10

(52) U.S. Cl. 703/2

(57) ABSTRACT

Methods and systems for modeling arc behavior are described. In an exemplary embodiment, the method includes the steps of determining electrical conductivity distribution in an arc and determining a current density distribution of the arc based on the determined electrical conductivity.

### BACKGROUND OF INVENTION

This invention relates generally to circuit breakers, and more particularly, to modeling arc interruption.

A circuit breaker typically includes a stationary contact and a movable contact located in an arc chamber. During normal operation, i.e., when no fault occurs, the movable contact is in electrical contact with the stationary contact, and current at a rated level flows through the breaker.

Once a fault occurs, the movable contact moves away from the stationary contact to interrupt current flow. When such interruption occurs, an arc is generated between the movable and stationary contacts and the electricity at the electrodes, i.e., the contacts, causes the medium (e.g., air, SF6) between the electrodes to ionize, commonly referred to as a plasma stage. The temperature of the medium in the plasma stage ranges between, for example, 10,000-20,000 K. At such temperatures, ionized iron, silver and other kinds of vapors from the electrodes, or other materials in the vicinity of the arc, contribute to the plasma.

Various techniques can be used to extinguish an arc. Such techniques include, for example, cooling the arc via an ablative medium, stretching the arc by taking advantage of its self-induced and external magnetic field, and pushing the arc (via the influence of flow expansion and magnetic fields) inside arc chutes or splitter plates. If the arc voltage drop along with the voltage drop across a system impedance are higher than the system voltage, the arc extinguishes and stays extinguished.

The physics governing the ionized plasma stage can be described as a coupling between gas dynamics, electrostatics and electromagnetism. Specifically, the electric field affects the energy equations via Joule heating, and the electromagnetic field along with the current flowing through the plasma affects the flow field via Lorentz forces. Gas dynamic equations, which are inherently non-linear in nature become more complex and non-linear because of the additional interactions with other types of physics.

At least some known arc behavioral models are generated based on empirical studies, and depend on experimental data. The variables in other types of circuit breakers, as well as under different operating conditions, alter arc behavior. Therefore, such models are not extendible to other types of breakers nor are such models for same type of breakers under different operating conditions. As a result, and in creating and attempting to optimize breaker design, numerous breakers typically are tested under various short circuit conditions, and different design types are evaluated using a build-and-bust mode. Such design techniques may not result in an optimized design. In addition, such techniques require time and resources, which increase the cost of circuit breaker design and development.

### SUMMARY OF INVENTION

In one aspect, a method for modeling electric arc behavior is described. The method includes the steps of determining electrical conductivity distribution in an arc, and determining a current density distribution of the arc based on the determined electrical conductivity. In an exemplary embodiment, the electrical conductivity distribution in the arc is determined using temperature and pressure distribution with an arc chamber. The current density distribution is determined using the electrical potential of the arc. Further, the magnetic fields and Joule heating are determined using the determined current density distribution, and magnetic forces are determined using the determined magnetic fields.

In another aspect, a system for modeling electric arc behavior is described. The system includes, in an exemplary embodiment, a server computer, a first client computer coupled to the server computer, and a second client computer coupled to the server computer. The first client computer is programmed to determine electrical conductivity distribution in an arc, and the second client computer is programmed to determine a current density distribution of the arc based on the determined electrical conductivity.

### BRIEF DESCRIPTION OF DRAWINGS

FIG. 1 is a schematic diagram of an arc chamber.

FIG. 2 is a schematic diagram of a system architecture.

FIG. 3 is a data flow diagram for performing computational fluid dynamics analysis.

### DETAILED DESCRIPTION

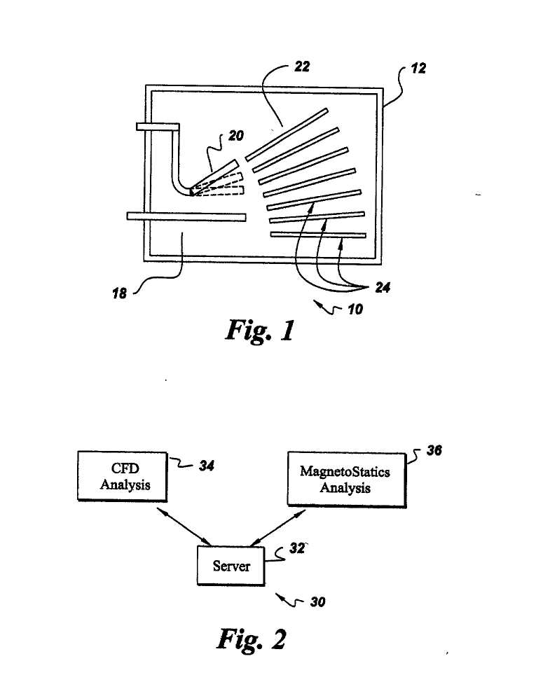

FIG. 1 is a schematic diagram of a typical arc chamber 10 of a breaker. Chamber is defined by a breaker case 12, and conductors designated as stationary 18 and movable contacts 20 are located in arc chamber. Contacts are in a normally closed condition so that current at a rated level can flow through the breaker. An arc chute 22 also is located in arc chamber. Arc chute includes a plurality of spaced plates.

In a first mode of operation, i.e., normal operation, movable contact 20 is in electrical contact with stationary contact 18, and current at a rated level flows through the breaker. In a second mode of operation, i.e., if a fault occurs, movable contact 20 moves away from stationary contact 18 to interrupt current flow, as illustrated in phantom in FIG. 1. When movable contact 20 moves away from stationary contact 18, an electric arc is generated. Also, when in the second mode, the electricity at the electrodes, i.e., the contacts, causes the medium (e.g., air, SF6) between the electrodes to ionize, resulting in a plasma stage. The temperature of the medium in the plasma stage ranges between, for example, 10,000-20,000 K. At such temperatures, ionized iron, silver and other kinds of vapors from the electrodes, or other materials in the vicinity of the arc, contribute to the plasma and can change arc properties.

The generated arc moves outward from contacts and is directed into arc chute 22. Specifically, the arc is split by the plates and the split portions of the arc are directed into spaces between adjacent plates 24. As a result of such splitting of the arc, the arc voltage increases and the arc is extinguished.

A model for determining arc behavior is described below. Such arc behavior model can be used, for example, in developing arc chute configurations for extinguishing arcs, as well as developing other mechanisms for extinguishing arcs.

More specifically, and referring to FIG. 2, a system 30 for modeling arc behavior includes a server 32 that communicates with client computers. Server and client computers are, in one embodiment, personal computers. One client computer is programmed to perform computational fluid dynamics (CFD) analysis 34 and other client computer is programmed to perform magnetostatics analysis 36. Of course, the specific architecture illustrated in FIG. 2 is exemplary only, and rather than having a client-server architecture, both the CFD analysis and the magnetostatics analysis could be performed on one computer, or on separate computers coupled via a network, such as a local area network or a wide area network (not shown).

Regarding client computer programmed to perform CFD analysis, a commercially available CFD software program, such as the Fluent program commercially available from Fluent Inc., is stored in computer memory. Of course, other commercially available CFD programs can be utilized. The Fluent program uses a set of partial differential equations commonly referred to as Navier Stokes equations and enthalpy or energy equations, along with an equation of state. The Fluent program generates values for flow velocity, pressure and temperature distributions in the plasma domain.

Further, using the user defined programming feature in the Fluent program, equations are incorporated into the Fluent program to extend the program capabilities. The equations incorporated into the Fluent program are set forth below. The terms that are underlined are not in the commercially available Fluent program and therefore, such terms are added to the program via the user defined programming feature.

Generally, the equations set forth below extend the commercially available Fluent program to capture the physics typical for an electric arc and the plasma stage. Radiation is defined using an optically thin medium approximation, while the plasma properties are defined as a function of temperature and pressure. An additional set of partial differential equation is provided to solve for electric potential, and the current densities are derived based on their relation to electric potential. The magnetic flux is evaluated using Biot-Savart law, which is an integral equation, relating the electric field and the position vectors.

$$• \text{Continuity Equation}$$

$$\frac{\partial ρ ( T , p )}{\partial t} + ∇ \cdot ( ρ ( T , p ) \overline{V} ) = 0$$

$$• \text{Momentum Equation:}$$

$$\frac{\partial ρ ( T , p ) \overline{V}}{\partial t} + ∇ \cdot ( ρ ( T , p\_ \overline{V} \overline{V} ) = \underline{\overline{J} \times \overline{B}} + ρ ( T , p ) \cdot x \overline{g} - ∇ ρ + ∇ \cdot \overline{τ} \\ • \text{Enthalpy Equation} \\ T , p \\ \frac{\partial ρ ( T , p ) h ( T , p )}{\partial t} + ∇ \cdot ( ρ ( T , p ) \overline{V} h ( T , p ) ) = ∇ \cdot ( k ( T , p ) ∇ T ) + \frac{\partial ρ}{\partial t} + ∇ \cdot ( p \overline{V} ) - \underline{{S}_{R} ( T , p )} + \underline{\overline{J} \cdot \overline{E}} + φ \\ • \text{Equation of state:} \\ p = ρ R T \\ • \text{Species Transport Equation} \\ \frac{\partial ρ ( T , p )}{\partial t} + ∇ \cdot ( ρ ( T , p ) \overline{V} ) = 0 \\ • \text{Current Continuity Equation:} \\ \underline{∇ \cdot ( σ ( T , p ) ∇ Φ ) = 0} \\ • \text{where, Current density:} \\ \overline{\underline{J}} = σ ( T , p ) \cdot \overline{E} = \underline{- σ ( T , p ) \cdot ∇ Φ} \\ • \text{Magnetic Flux Density:} \\ \underline{\overline{B} ( \overline{r} ) = {\overline{B} ( \overline{r} )}_{ex1} + \frac{{μ}_{0}}{4 π} {\int \int \int }_{{v}^{′}} \overline{J} ( {\overline{r}}^{′} ) \times \frac{\overline{r} - \overline{r}}{{\vert \overline{r} - \overline{r} \vert}^{3}} ⅆ {V}^{′}}$$

In order to define additional quantities to be solved for, or any other physical quantities for post-processing, the Fluent program requires users to define user defined scalars (UDS). For a two-dimensional and axi-symmetric implementation of the plasma modeling, up to 8 UDSs are used, while for a three-dimensional implementation, 15 UDSs are used.

Client computer is programmed using a commercially available electromagnetic software program such as the MagNet program commercially available from Infolytica Corporation. Of course, other electromagnetic software can be utilized. The MagNet program solves a set of partial differential equations commonly referred to as Maxwell's equations.

In operation, and as explained above, client computer in which the Fluent program resides solves the electro-statics equation. The electrical conductivity, which is a function of temperature distribution, is evaluated throughout the plasma region and stored in a defined file format by the Fluent program. The file, generated by the Fluent program, is communicated via server 32 to client computer in which the MagNet program resides. Once the file is transferred to client computer, the MagNet program uses the electrical conductivity distribution in the plasma region from the file and solves the magneto-static equations to generate a magnetic flux and electric flux density distribution. The magnetic flux and electric flux density distribution are stored in a defined file format by the MagNet program.

The file generated by the MagNet program is then transferred, via server 32, to client computer in which the Fluent program resides. The file from the MagNet program is then used by the Fluent program for the next iteration of calculations. Specifically, once the magnetic flux and electric flux density is determined by the MagNet program, these terms are used to determine the source term in the momentum and energy equation in the Fluent program.

The Fluent program in client computer remains active throughout the entire process. If the Fluent program is terminated while transferring the file and running the MagNet program, the transient analysis would lose information about previous time step or iteration, which would hinder proper transient simulation.

In addition, the circuit equations are coupled with field equations, i.e. the gas dynamics, electrostatics and magnetostatics equations. Depending on the arc resistance, which is a function of temperature, the overall impedance of the system under arcing conditions dynamically changes as the flow and temperature field changes. As a result, overall current at the electrode also changes. This dynamic behavior can be solved by coupling the circuit equations with the field equations. Therefore, the circuit equations are solved to provide the appropriate boundary conditions for the electrostatic equations.

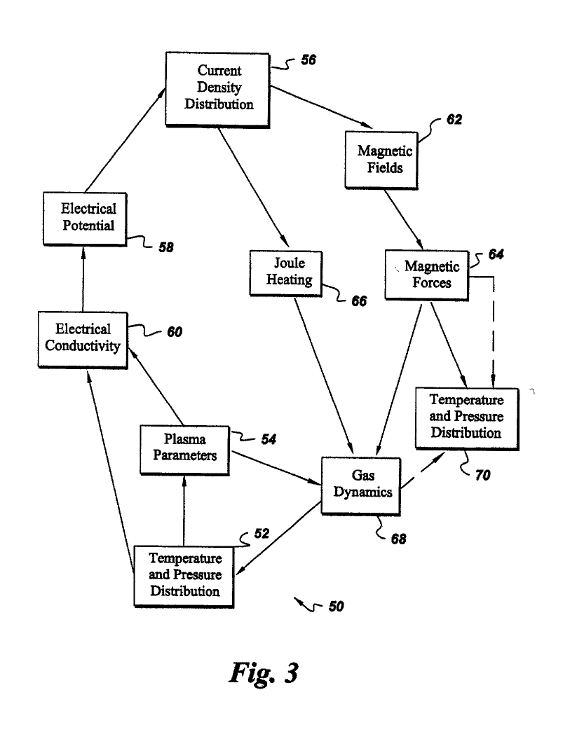

FIG. 3 is a data flow diagram 50 illustrating a sequence for modeling arc behavior. Specifically, electrical conductivity distribution in an arc is determined using the Fluent program in client computer. On the first iteration, electrical conductivity distribution is based on temperature and pressure distribution 52 as well as plasma parameters 54. The electrical conductivity values are stored in the defined file format by the Fluent program, and then communicated to client computer in which the MagNet program resides. The MagNet program then determines current density distribution 56 based on the electrical potential 58 determined from the electrical conductivity 60. The MagNet program also determines magnetic fields 62, magnetic forces 64, and Joule heating 66 from the current density distribution. The determined Joule heating and magnetic forces, along with the previously determined plasma parameters, are then used for determining gas dynamics field 68. For a next iteration, the gas dynamics field are then used to determine temperature and pressure distribution 70.

While the invention has been described in terms of various specific embodiments, those skilled in the art will recognize that the invention can be practiced with modification within the spirit and scope of the claims.

1. A method for modeling electric arc behavior, said method comprising the steps of:
determining electrical conductivity distribution in an arc;
determining a current density distribution of the arc based on the determined electrical conductivity.

2. A method according to claim 1 wherein electrical conductivity distribution in the arc is determined using temperature and pressure distribution with an arc chamber.

3. A method according to claim 1 wherein determining current density distribution comprises the step of determining electrical potential of the arc.

4. A method according to claim 1 further comprising the steps of:
determining magnetic fields and Joule heating using the determined current density distribution; and
determining magnetic forces from the determined magnetic fields.

5. A method according to claim 4 further comprising the step of determining gas dynamics field using the determined Joule heating and magnetic forces.

6. A system for modeling electric arc behavior, said system comprising:
a server computer;
a first client computer coupled to said server computer, said first client computer programmed to determine electrical conductivity distribution in an arc; and
a second client computer coupled to said server computer, said second client computer programmed to determine a current density distribution of the arc based on the determined electrical conductivity distribution.

7. A system according to claim 5 wherein said first client computer is programmed to determine electrical conductivity distribution in the arc using temperature and pressure distribution with an arc chamber.

8. A system according to claim 5 wherein said second client computer is programmed to determine electrical potential of the arc.

9. A system according to claim 5 wherein said second client computer is further programmed to determine magnetic fields and Joule heating using the determined current density distribution, and magnetic forces from the determined magnetic fields.

10. A system according to claim 9 wherein said second client computer is further programmed to determine gas dynamics field using the determined Joule heating and magnetic forces.
